(19) United States
(12) Patent Application Publication
(10) Pub. No.: US 2012/0120198 A1
(43) Pub. Date: May 17, 2012

(54) THREE-DIMENSIONAL SIZE MEASURING SYSTEM AND THREE-DIMENSIONAL SIZE MEASURING METHOD

(75) Inventors: Chi-Yeh Yu, Taipei City (TW); Shih-Hung Yen, Taipei County (TW); Chia-Hao Liang, Taichung County (TW); Chun-Tai Yen, Taipei City (TW)

(73) Assignee: INSTITUTE FOR INFORMATION INDUSTRY, Taipei (TW)

(21) Appl. No.: 13/108,017

(22) Filed: May 16, 2011

(30) Foreign Application Priority Data
Nov. 17, 2010 (TW) 99139566

(51) Int. Cl. H04N 13/02; G06K 9/60

(52) U.S. Cl. 348/46; 382/154; 348/E13.074

(57) ABSTRACT

A system for measuring a three-dimensional (3D) size of an object in a space according to an indicating mark is provided, wherein the indicating mark is used to point to one of a plurality of measuring points on the object. The system includes an image capturing module, an spatial vector calculating module, and a measuring module. The image capturing module captures an image of the space. The spatial vector calculating module respectively calculates a spatial vector corresponding to the indicating mark when the indicating mark is used to point to each of the measuring points on the object in the image. The measuring module calculates spatial coordinates of the measuring points according to the spatial vectors so as to obtain the 3D size of the object.

### CROSS-REFERENCE TO RELATED APPLICATION

This application claims the priority benefit of Taiwan application serial no. 99139566, filed Nov. 17, 2010. The entirety of the above-mentioned patent application is hereby incorporated by reference herein and made a part of this specification.

### BACKGROUND OF THE INVENTION

1. Field of the Invention

The invention generally relates to a system and a method for measuring a size, and more particularly, to a system and a method for measuring a three-dimensional (3D) size.

2. Description of Related Art

Object measuring is usually categorized into two-dimensional (2D) picture measuring and three-dimensional (3D) object measuring. In 2D picture measuring, an image of the picture to be measured is captured by using an image capturing apparatus with a charge-coupled device (CCD), and image processing (for example, smoothing process, edge enhancement process, and noise elimination process) is then performed on the captured image to increase the quality of the image. Thereafter, the size of the 2D picture is calculated based on an image measuring principle according to the size and pixel size of the CCD. However, the technique of measuring a size according to an image captured by a CCD is only applicable to 2D pictures.

In 3D object measuring, a depth information is further associated with each pixel of a 2D image to transform the 2D image into a 3D image. After that, 3D measuring (for example, triangulation, structured light scanning, and time of flight) is performed in a contactless manner (for example, through sound waves or optical measurement). However, a common problem of existing 3D measuring techniques is that a specific video camera and a special transmitting apparatus (for example, an apparatus that can emit a laser or infrared beam or a structured light in a specific mode) have to be adopted, and 3D measuring can only be performed on an 3D object after the transmitting apparatus transmits a sound wave or optical wave and the specific video camera receives the sound wave or optical wave reflected by the 3D object. Thereby, the cost of equipment deployment is increased.

### SUMMARY OF THE INVENTION

Accordingly, the invention is directed to a system and a method for measuring a three-dimensional (3D) size and a computer-readable recording medium, wherein the size of a 3D object in an irregular shape is measured according to an indicating mark, and a rear measuring point on the object can be measured when the indicating mark is not completely shielded, so that the convenience in using the system and the measurement accuracy are both improved.

The invention provides a 3D size measuring system for measuring an object in a space according to an indicating mark, wherein the indicating mark is used to point to one of a plurality of measuring points on the object. The 3D size measuring system includes an image capturing module, a spatial vector calculating module, and a measuring module. The image capturing module captures an image of the space. According to the indicating mark pointing to each of the measuring points on the object in the image, the spatial vector calculating module respectively calculates a spatial vector corresponding to the indicating mark pointing to each of the measuring points. The measuring module calculates spatial coordinate of each of the measuring points according to the spatial vectors, so as to obtain a 3D size of the object.

The invention also provides a 3D size measuring method adaptable to an electronic device for measuring an object in a space according to an indicating mark, wherein the indicating mark is used to point to one of a plurality of measuring points on the object. The electronic device executes following steps of the 3D size measuring method. An image of the space is captured. According to the indicating mark pointing to each of the measuring points on the object in the image, a spatial vector corresponding to the indicating mark pointing to each of the measuring points is respectively calculated. Spatial coordinate of each of the measuring points are calculated according to the spatial vectors to obtain a 3D size of the object.

The invention further provides a computer-readable recording medium for storing a 3D size measuring program, wherein the 3D size measuring program allows an electronic device to measure an object in a space according to an indicating mark, and the indicating mark is used to point to one of a plurality of measuring points on the object. The 3D size measuring program has a plurality of instructions for executing following steps. An image of the space is captured. According to the indicating mark pointing to each of the measuring points on the object in the image, a spatial vector corresponding to the indicating mark pointing to each of the measuring points is respectively calculated. Spatial coordinate of each of the measuring points are calculated according to the spatial vectors to obtain a 3D size of the object.

According to another embodiment of the invention, in the 3D size measuring system, the 3D size measuring method, and the computer-readable recording medium described above, at least one mark reference parameter of the indicating mark may be recorded in advance.

According to another embodiment of the invention, in the 3D size measuring system, the 3D size measuring method, and the computer-readable recording medium described above, the step of respectively calculating the spatial vector corresponding to the indicating mark pointing to each of the measuring points on the object further includes following sub-steps. A regional image corresponding to the indicating mark is determined in the image. The regional image is compared with the mark reference parameter provided by an indicating mark parameter module. A correlation reliability between the regional image and the indicating mark is determined. When the correlation reliability is high, the moving regional images around the regional image is tracked so that the spatial vectors corresponding to the indicating mark pointing to each of the measuring points is calculated according to a comparison made by the compare module between each of the moving regional image and at least one mark reference parameter provided by the indicating mark parameter module. When the correlation reliability is low, the regional image corresponding to the indicating mark pointing to each of the measuring points is re-determined in the image, so as to calculate the spatial vectors corresponding to the indicating mark pointing to each of the measuring points according to the comparison made by the compare module between each of the regional image and the mark reference parameter provided by the indicating mark parameter module.

As described above, the invention provides a 3D size measuring system, a 3D size measuring method, and a computer-readable recording medium, wherein a spatial vector of an indicating mark in a space is instantly calculated according to a measuring point on an object pointed by the indicating mark, and spatial coordinates of the measuring point is then calculated according to the spatial vector. The 3D size of the object can be obtained based on the spatial coordinates of a plurality of measuring points. Moreover, the indicating mark includes a mark portion and an indicator portion extending outwards from the mark portion. The indicator portion is used to point to the measuring points on the object, and measuring points at the rear (which is not displayed in the image captured by the system) of the object can be pointed by the indicator portion and measured as long as the indicating mark is not completely shielded in the captured image. Thereby, both the convenience in using the system and the measurement accuracy are greatly improved.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating how a three-dimensional (3D) size of an object is measured by using a 3D size measuring system according to an embodiment of the invention.

FIG. 2 is a diagram of a 3D size measuring system according to an embodiment of the invention.

FIG. 3 is a diagram of a spatial vector calculating module in FIG. 2.

FIG. 4 is a partial view of a 3D size measuring system according to another embodiment of the invention.

FIG. 5 is a flowchart of a 3D size measuring method according to yet another embodiment of the invention.

FIG. 6 is a flowchart illustrating a step in FIG. 5 for calculating spatial vectors.

FIG. 7 is a partial flowchart of a 3D size measuring method according to still another embodiment of the invention.

FIG. 8 is a diagram illustrating how a spatial relationship between a 3D size of an object and a 3D virtual space is measured by using a 3D size measuring system according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

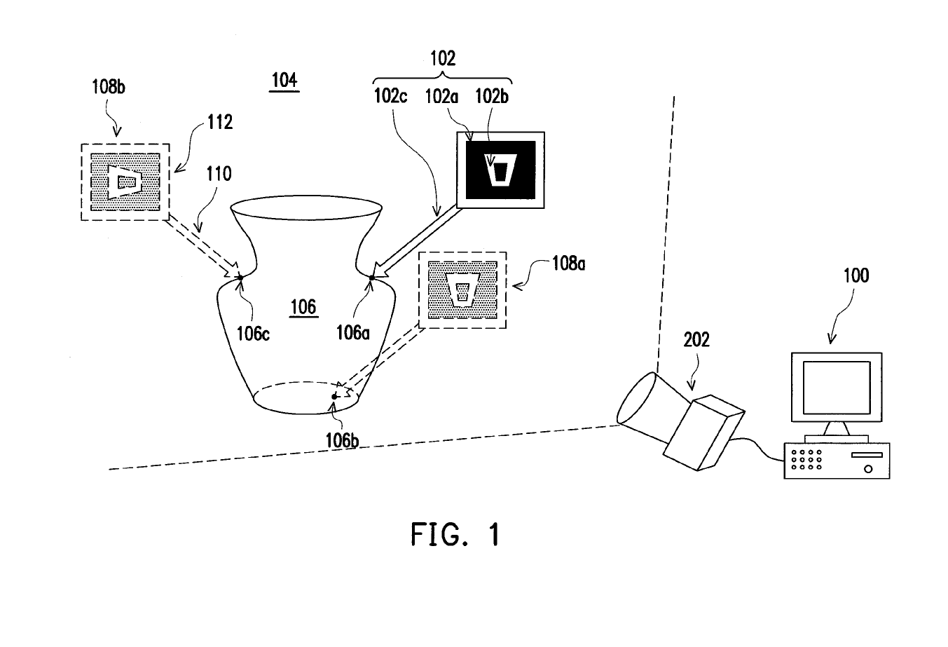

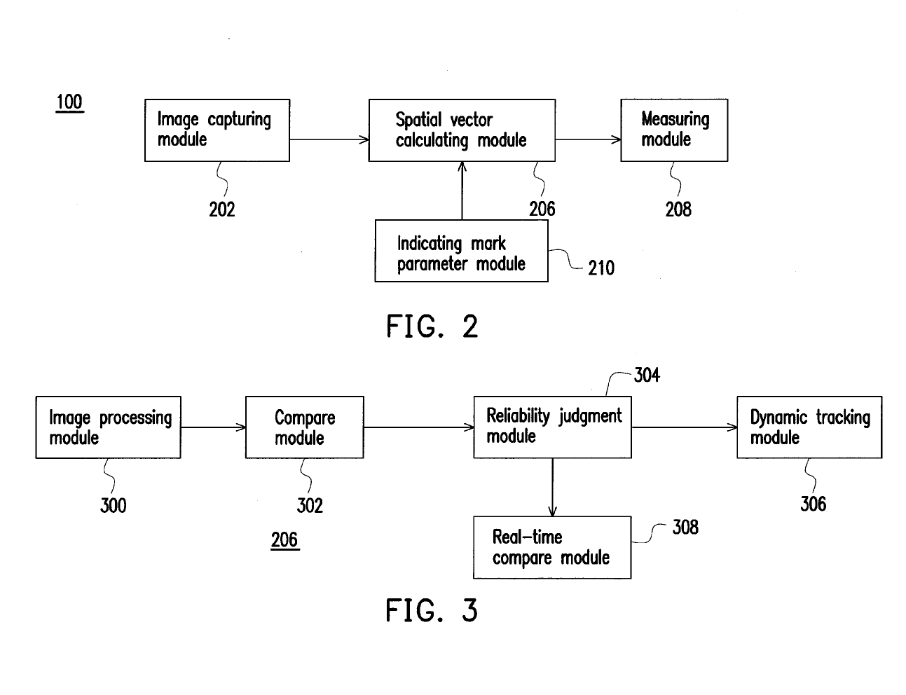

FIG. 1 is a diagram illustrating how a three-dimensional (3D) size of an object is measured by using a 3D size measuring system according to an embodiment of the invention. FIG. 2 is a diagram of a 3D size measuring system according to an embodiment of the invention. Referring to FIG. 1, the 3D size measuring system 100 in the present embodiment can measure an object 106 in a space 104 according to an indicating mark 102. The indicating mark 102 is used to point to one of a plurality of measuring points (for example, measuring points 106a, 106b, and 106c) on the object 106. It should be noted that the measuring points 106a, 106b, and 106c may be located anywhere on the object 106 (for example, on the front, side, or back of the object 106, or any point which the indicating mark 102 randomly moves on the object 106 during the measuring process).

Referring to FIG. 2, in the present embodiment, the 3D size measuring system 100 includes an image capturing module 202, a spatial vector calculating module 206, and a measuring module 208. The image capturing module 202 may be any device with image capturing function, such as a camera, a video camera, a digital camera, or a digital video camera. A single image or a video composed of stream data may be captured by the image capturing module 202.

It should be noted that in the present embodiment, the indicating mark 102 may include a mark portion 102a (having at least one identification pattern 102b, referring to FIG. 1) and an indicator portion 102c (for pointing to a specific measuring point on the object 106) extending outwards from the mark portion 102a. In FIG. 1, the mark portion 102a is square shape, and the identification pattern 102b is located in the center of the mark portion 102a and is a white trapezoid frame. However, the shape/color of the mark portion, the pattern/location/shape/color of the identification pattern, and the relative disposition between the mark portion 102a and the identification pattern 102b are not limited to these in the invention. To be specific, the mark portion 102a may be in any color and any shape (for example, in a square shape, a rectangular shape, a triangular shape, an elliptical shape, or a polygonal shape) as long as it can be used for the direction identification. Namely, the indicating mark 102 is randomly placed in the space, and when the indicating mark 102 is placed at different positions, rotation angles, and deflections relative to the image capturing module 202, the shape of the indicating mark in the captured image reveals different deformations. Accordingly, the system provided by the invention can obtain the rotation angle and rotation direction of the indicating mark according to the deformation of the mark portion 102a in the image, calculate the spatial vectors of the measuring points respectively, and then obtain the 3D size of the object. In other words, the mark portion is designed to provide information related to the rotation angle and rotation direction of the indicating mark in the space through graphics. In addition, the identification pattern 102b may be any shape, symbol, and/or pattern. The identification pattern 102b is usually implemented as an asymmetrical graphics such that the rotation direction thereof can be easily determined. Preferably, the identification pattern 102b should be conveniently differentiated from the object to the measured in the image so that in subsequent 3D size measuring process, the indicating mark 102 can be instantly identified in the captured image.

Additionally, the 3D size measuring system 100 may further include an indicating mark parameter module 210 for recording at least one mark reference parameter of the indicating mark 102. Namely, mark reference parameters related to the indicating mark 102 at different positions or different rotation angles or deflections relative to the image capturing module 202 are recorded in advance, wherein the mark reference parameters may be the relative coordinates of a specific point in the mark portion 102a, the size and color of each side or a line between two end points of the mark portion 102a, the relative coordinates of a specific point in the identification pattern, the size and color of each side or a line between two end points of the identification pattern, or other parameters that can be used for feature identification. In an embodiment of the invention, the indicating mark parameter module 210 records mark reference parameters of the indicating mark 102 that fronts the image capturing module 202 and also records mark reference parameters which are rotated and deflected to the image capturing module 202, and then the indicating mark parameter module 210 compensates according to the mark reference parameters of the indicating mark 102 fronting the image capturing module 202. Generally speaking, the more mark reference parameters of the indicating mark 102 for various degree rotation and deflection in the space are recorded by the indicating mark parameter module 210, the faster the spatial vectors corresponding to the measuring points are calculated.

Referring to FIG. 3, in another embodiment, the spatial vector calculating module 206 further includes an image processing module 300, a compare module 302, a reliability judgement module 304, a dynamic tracking module 306, and a real-time compare module 308.

The image processing module 300 determines a regional image corresponding to the indicating mark in the captured image. In other embodiments, the image processing module 300 may process the captured image through following steps. First, the image processing module 300 performs a color simplification process (for example, different color scales (including gray scale) processing on the captured image. Then, the image processing module 300 averages image values of the captured image to uniform the brightness of the entire captured image. Next, the image processing module 300 scans the captured image to differentiate various color blocks in the image according to the mark reference parameters of the mark portion 102a provided by the indicating mark parameter module 210, and the image processing module 300 obtains candidate image blocks that could be the mark portion of the indicating mark through image segmentation and block merging. Thereafter, the image processing module 300 performs geometrical feature comparison and shape filters according to the mark reference parameters of the identification pattern 102b provided by the indicating mark parameter module 210 and selects one of the candidate image blocks as the regional image corresponding to the indicating mark 102 in the space 104. Namely, a regional image corresponding to the indicating mark 102 in the space is determined in the captured image through a series of image processing operations (including color differentiation, image segmentation and merging, geometrical feature comparison, and shape selection) according to identification features in the identification pattern.

The compare module 302 compares the regional image with the mark reference parameters provided by the indicating mark parameter module 210. The reliability judgement module 304 determines a correlation reliability (i.e., similarity) between the regional image and the indicating mark. The correlation reliability may be determined by comparing the regional image with the characteristic values of the indicating mark. One technique for determining the correlation reliability is to average the product of a band transfer function and a discrete cosine transform (DCT). The level of the similarity can be determined based on a threshold. For example, if the threshold is 0.5, the similarity level is determined to be high if the value thereof is over 0.5.

When the correlation reliability (i.e., the similarity level) is high, the dynamic tracking module 306 tracks the moving regional images respectively corresponding to the indicating mark 102 pointing to the measuring points on the object around the regional image, so that the dynamic tracking module 306 calculates the spatial vectors corresponding to the indicating mark when the indicating mark 102 is used to point to each of the measuring points according to a comparison made by the compare module 302 between each of the moving regional image and the at least one mark reference parameter provided by the indicating mark parameter module 210.

For example, when the indicating mark 102 is used to point to a measuring point on the object 106, since the correlation reliability between the regional image and the indicating mark is high, the system needs not to scan the entire captured image or re-determine the regional image corresponding to the indicating mark if the indicating mark 102 continuously moves to other positions and the image capturing module 202 keeps capturing images. Instead, the system simply tracks the moving regional images corresponding to the moving indicating mark around the determined regional image. Thereby, the quantity of data to be processed is reduced.

When the correlation reliability is low, the real-time compare module 308 re-determines the regional image corresponding to the indicating mark 102 in the image through the image processing module 300 so as to calculate the spatial vectors corresponding to the indicating mark when the indicating mark is used to point to the measuring points according to the comparison made by the compare module 302 between each of the regional image and the mark reference parameters provided by the indicating mark parameter module 210. Namely, when the indicating mark 102 is moved and used to point to the measuring points on the object 106, because the correlation reliability between the determined regional image and the indicating mark is low, the entire captured image needs to be re-scanned and the regional image corresponding to the moved indicating mark 102 needs to be re-determined every time when the indicating mark 102 moves in order to calculate the spatial vectors corresponding to the indicating mark 102.

In another embodiment, the indicator portion 102c of the indicating mark 102 is used to point to a measuring point on an object or any point in the space, and can be any shape and graphics for pointing to a specific point, such as a long arrow (as shown in FIG. 1). The indicating mark parameter module 210 records parameters related to the indicator portion 102c, wherein the parameters include a vector (length and direction) of the indicator portion 102c extending outwards from the mark portion 102a. When the indicating mark 102 is moved and pointed to the measuring points, the indicator portion 102c (for example, the tip of the arrow) is used to touch the measuring points on the object 106 for indicating mark 102. The spatial vector calculating module 206 obtains the spatial coordinates of the measuring points according to the mark reference parameters provided by the indicating mark parameter module 210 through spatial coordinate calculation and vector compensation.

On the other hand, when the image capturing module 202 captures an image of the space in which the object 106 is located, if the mark portion 102a is not shielded in the captured image, the spatial vector calculating module 206 can also calculate the spatial coordinates of the rear measuring point on the object even the indicator portion 102c is used to point to a rear measuring point on the object opposite to the image capturing module 202. In other words, the 3D size measuring system in the invention can measure the 3D spatial coordinates of the object in 360°. Namely, besides calculating the spatial coordinates of measuring points on the front of the object 106 in the image captured by the image capturing module 202, the spatial coordinates of rear measuring points on the object can also be calculated by appropriately rotating and placing the indicating mark 102 to make the mark portion 102a of the indicating mark 102 not be shielded and the indicator portion 102c be used to point to and contacts the rear of the object 106. In other words, the measuring of the 3D size of the object can still be performed by the 3D size measuring system in the invention when the indicator portion 102c is partially or completely shielded. The 3D size measuring system also can be used to measure the measuring points on the object that are not shown in the captured image (for example, on the side or back of the object, or the measuring point which is be shielded).

For example, referring to FIG. 1, opposite to the image capturing module 202, the measuring points 106a and 106b are located on the front of the object 106, and the measuring point 106c is located on the back of the object 106. Namely, the measuring point 106c is not seen in the image captured by the image capturing module 202. To measure the measuring point 106c, the tip of the indicator portion 110 is used to point to the measuring point 106c. Because the mark portion 112 of the indicating mark 108b is not shielded by any opaque object, the spatial vector corresponding to the measuring point 106c can be calculated through, for example, spatial coordinate calculation and vector compensation.

In another embodiment, the measuring module 208 in the 3D size measuring system further includes a line segment measuring module. The line segment measuring module calculates the distance between any two of a plurality of measuring points on the object 106 according to the spatial coordinates of the measuring points.

On the other hand, in yet another embodiment, the measuring module 208 in the 3D size measuring system further includes a track recording module. The track recording module records the spatial coordinates of the measuring points on the object 106 according to a sequence of the measuring points on the object 106 which the indicating mark 102 is used to sequentially point to, so as to calculate a measurement path of the indicating mark 102. For example, besides establishing the measurement path of the indicating mark 102, the total length of the measurement path can be further calculated through an integral operation based on the spatial coordinates of the measuring points on the object 106 sequentially recorded by the track recording module. The image capturing frequency on the measurement path can be determined according to the specification of the camera. In general, the image capturing frequency is 24 or 30 pages per second, and it can be up to 60 pages per second for higher quality.

Embodiments of the 3D size measuring system and the 3D size measuring method provided by the invention are described above, wherein the spatial coordinates and size of a 3D object in a space are measured. However, the invention is not limited thereto. Below, how to measure a spatial relationship between the 3D size of an object and a virtual space and plot a digital model by using the 3D size measuring system and the 3D size measuring method in the invention will be described with reference to some embodiments and accompanying drawings. It should be noted that in following embodiments, those elements that are the same as or similar to those in foregoing embodiments will be marked with the same reference numerals.

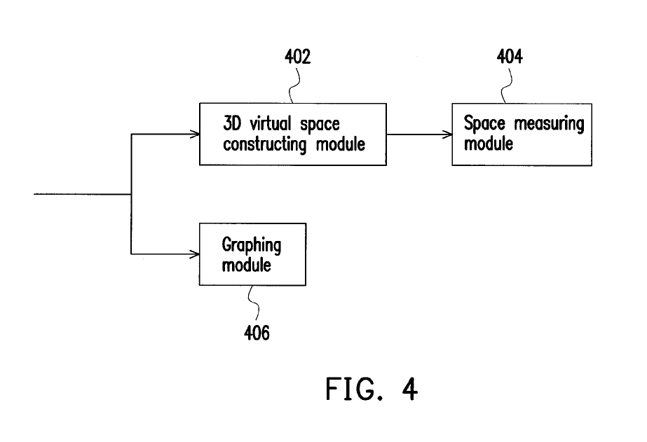

FIG. 4 is a partial view of a 3D size measuring system according to another embodiment of the invention. Referring to FIG. 4, in the present embodiment, besides the image capturing module 202, the spatial vector calculating module 206, and the measuring module 208, the 3D size measuring system further includes a 3D virtual space constructing module 402 and a space measuring module 404. The 3D virtual space constructing module 402 constructs a 3D virtual space in a spatial coordinate system corresponding to the captured image. The space measuring module 404 measures a spatial relationship between the 3D size of the object 106 and the 3D virtual space. The spatial coordinate system refers to a space composed of the Cartesian coordinate system, wherein the space and the entire image are corresponding to a spatial coordinate system with axes x, y, and z, and a 3D virtual space is constructed in the spatial coordinate system.

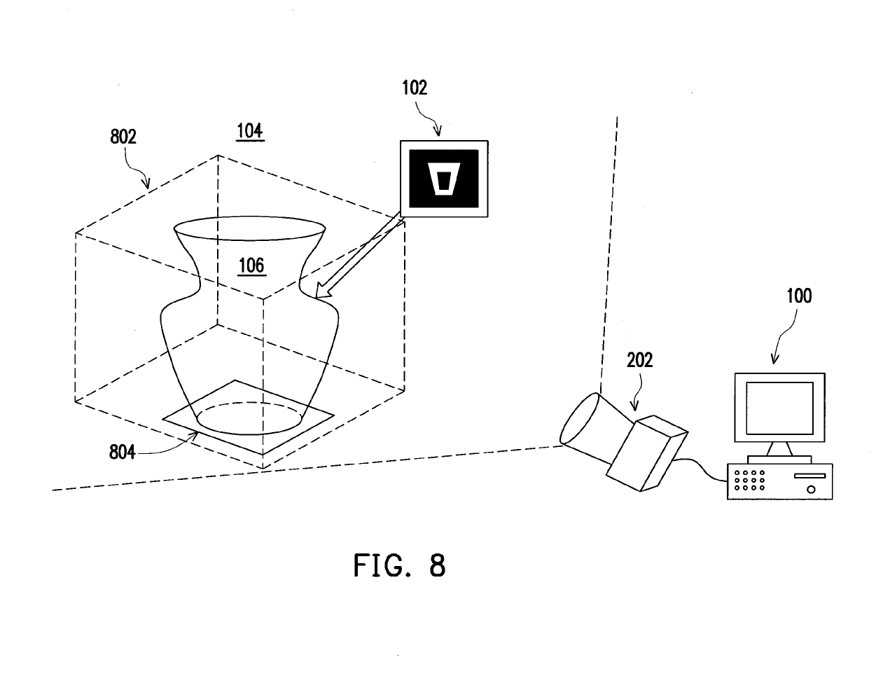

For example, as shown in FIG. 8, the 3D virtual space constructing module 402 constructs a 3D virtual space 802 for the captured image based on the spatial coordinate system corresponding to the space 104. To be specific, the 3D virtual space constructing module 402 can construct the 3D virtual space 802 based on a positioning mark 804 in the space 104. Herein the 3D virtual space 802 may be a virtual image of a physical object (for example, a virtual image of a carton box or various soft/hard container) or a virtual image established by using known size conditions (for example, a virtual image established by using a standard parcel size of the post office or a clothing virtual image established by using actual measurements). Thereafter, the space measuring module 404 measures a spatial relationship (for example, a size relationship) between the 3D size of the object 106 and the 3D virtual space according to the 3D size of the object 106 measured by the measuring module 208 and the 3D virtual space 802 constructed by the 3D virtual space constructing module 402. For example, the space measuring module 404 determines whether the object 106 can be contained into the space of the 3D virtual space 802, whether the 3D virtual space 802 can be constructed inside the object 106, or whether the 3D virtual space 802 is closed to the object 106 when the 3D virtual space 802 is outside the object 106. Accordingly, the 3D size measuring system in the invention can be applied to various non-physical channels to provide virtual fitting, transportation, and space deployment services by measuring a spatial relationship between a physical object and a 3D virtual space.

Additionally, in another embodiment, the 3D size measuring system 100 further includes a graphing module 406. The graphing module 406 plots a digital content of the object 106 according to the spatial coordinates of the measuring points obtained by the measuring module 208, wherein the digital content can be a 3D virtual image, a 3D model, or a picture of the object 106. Namely, a digital content (for example, a 3D virtual image) of a physical object is rendered according to the spatial coordinates of the measuring points, such that a user can develop various digital applications (for example, animation and simulation) based on the 3D virtual image.

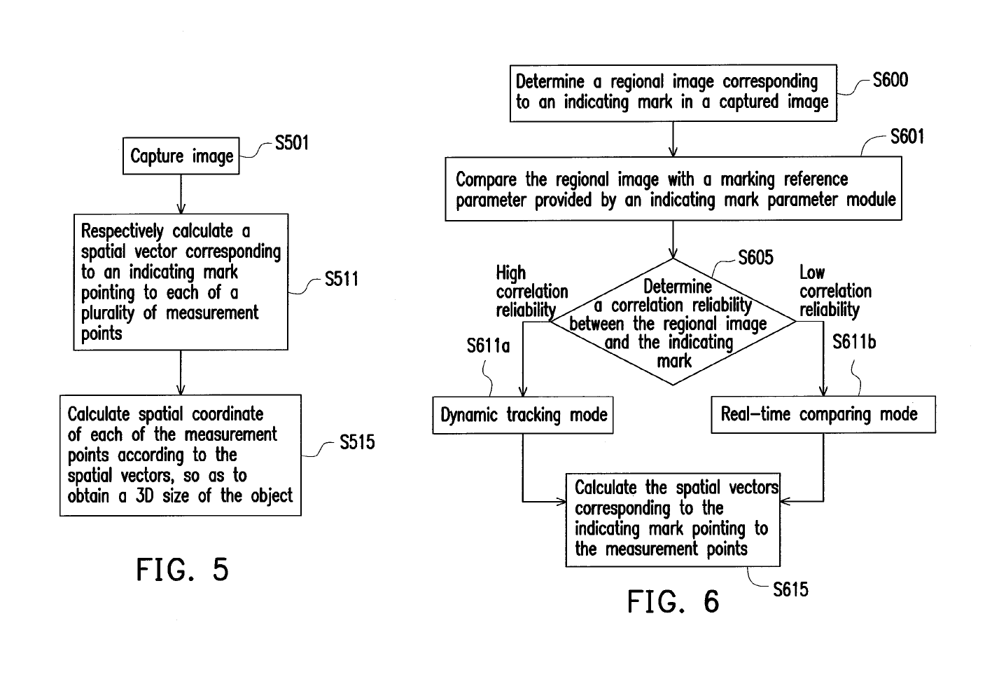

FIG. 5 is a flowchart of a 3D size measuring method according to yet another embodiment of the invention. The 3D size measuring method is adaptable to an electronic device for measuring an object in a space according to an indicating mark, wherein the indicating mark is used to point to a measuring point on the object. The electronic device may be any type of computer (for example, a personal computer, a notebook computer, or a tablet computer), a personal digital assistant (PDA), a cell phone, a portable device, or any other computing device. Various modules (the image capturing module 202, the spatial vector calculating module 206, and the measuring module 208) in the system illustrated in FIG. 2 may be disposed in the same electronic device or respectively disposed in different electronic devices and then connected with each other in a wireless or wired manner. Referring to FIG. 5, in step S501, an image of the space 104 is captured. Then, in step S511, a spatial vector corresponding to the indicating mark 102 when the indicating mark 102 is used to point to each of the measuring points (for example, the measuring points 106a, 106b, and 106c) on the object 106 is respectively calculated according to the captured image. For example, as shown in FIG. 1, when the indicating mark 102 is used to respectively point to the measuring points 106b and 106c, the spatial vectors of the indicating marks 108a and 108b are respectively calculated. It should be noted that the spatial vector may be the plane normal vector of the indicating mark 102. To be specific, it is the unit plane normal vector of the mark portion 102a of the indicating mark 102 plus a position vector rotating on a plane, and which can be used for determining the position of the indicating mark. In step S515, spatial coordinate of each of the measuring points is calculated according to the spatial vectors, so as to obtain a 3D size of the object.

FIG. 6 is a flowchart illustrating the step S511 in FIG. 5 for calculating a spatial vector when the indicating mark is used to point to a measuring point. In step S600, a regional image corresponding to the indicating mark is determined in the image. In step S601, the regional image is compared with the mark reference parameters provided by the indicating mark parameter module. In step S605, a correlation reliability between the regional image and the indicating mark is determined. If the correlation reliability is high, step S611a is executed, and if the correlation reliability is low, step S611b is executed. In step S611a (in a dynamic tracking mode), when the correlation reliability is high, the moving regional image respectively corresponding to the indicating mark pointing to each of the measuring points on the object is tracked around the regional image, so as to calculate the spatial vectors corresponding to the indicating mark when the indicating mark is used to point to the measuring points according to a comparison made by the compare module between each of the moving regional image and the mark reference parameter provided by the indicating mark parameter module. In step S611b (in a real-time comparing mode), when the correlation reliability is low, the regional image corresponding to the indicating mark when the indicating mark is used to point to each of the measuring points is re-determined in the image, so as to calculate the spatial vectors corresponding to the indicating mark when the indicating mark is used to point to the measuring points according to the comparison between each of the regional image and the mark reference parameter. In step S615, the spatial vectors when the indicating mark is used to point the measuring points are calculated.

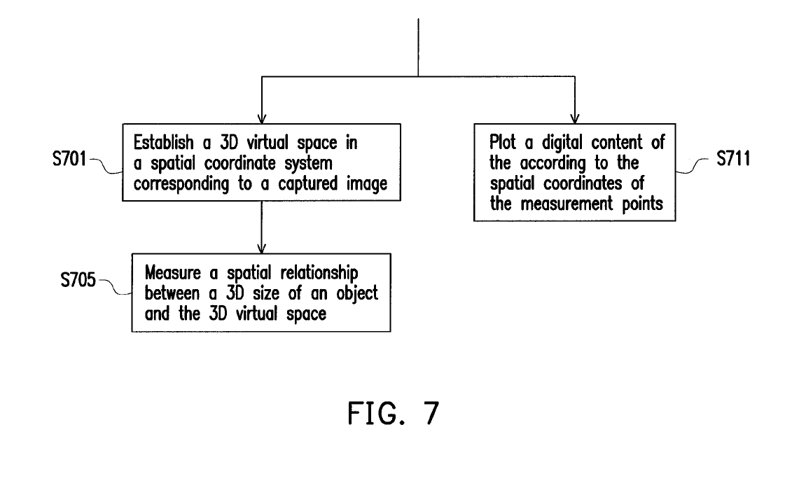

FIG. 7 is a partial flowchart of a 3D size measuring method according to still another embodiment of the invention. The present 3D size measuring method further includes following steps after step S515 or S615. In step S701, a 3D virtual space is constructed in a spatial coordinate system corresponding to the image. In step S705, a spatial relationship between the 3D size of the object and the 3D virtual space is measured.

In other embodiments, the present 3D size measuring method further includes following steps after step S515 or S615. In step S711, a corresponding digital content is plotted according to the spatial coordinates of the measuring points, wherein the digital content is a 3D virtual image, a 3D model, or a picture of the object.

In foregoing embodiment, the 3D size measuring method provided by the invention may be realized by executing a computer-readable program, and the 3D size measuring system may also be presented as foregoing computer-readable program. The computer-readable program can be stored in a computer-readable recording medium, and a plurality of instructions of the computer-readable program is executed by a processor to realize the 3D size measuring method in the invention. The steps of the 3D size measuring method have been described in detail in foregoing embodiments therefore will not be described herein.

In summary, the invention provides a 3D size measuring system and a 3D size measuring method, wherein a spatial vector of an indicating mark in a space can be instantly calculated by pointing the indicating mark to a measuring point and comparing the present regional image corresponding to the indicating mark with mark reference parameters, and spatial coordinates of the measuring point can be further calculated according to the spatial vector. A 3D size can be obtained according to the spatial coordinates of a plurality of measuring points. Because an indicator portion of the indicating mark extends outwards and is used to point to the measuring points, the spatial coordinates of a measuring point on a portion (for example, the side or back) of the object that cannot be seen in the captured image can still be measured by pointing the indicator portion to the measuring point that is not shown in the captured image as long as the mark portion of the indicating mark is not shielded in the captured image. Thereby, the convenience in using the system and the measurement accuracy are both improved. Moreover, regarding the measurement of the size of an object in an irregular shape, since the indicator portion of the indicating mark is used to point to the surface of the object, the spatial coordinates of the measuring points can be accurately calculated. The size of the irregular object can be accurately measured when the number of the measuring points reaches a certain extent. Furthermore, in the 3D size measuring system and 3D size measuring method provided by the invention, when the 3D size of an object is measured, the measuring range is determined by the indicating mark and is not affected by how accurate the object is identified in the captured image and requires no data training in advance. Accordingly, the cost for deploying the system is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A three-dimensional (3D) size measuring system, for measuring an object in a space according to an indicating mark, wherein the indicating mark is used to point to one of a plurality of measuring points on the object, the 3D size measuring system comprising:
an image capturing module, for capturing an image of the space;
a spatial vector calculating module, wherein, according to the indicating mark pointing to each of the measuring points on the object in the image, the spatial vector calculating module respectively calculates a spatial vector corresponding to the indicating mark pointing to each of the measuring points; and
a measuring module, for calculating spatial coordinate of each of the measuring points according to the spatial vectors, so as to obtain a 3D size of the object.

2. The 3D size measuring system according to claim 1, further comprising an indicating mark parameter module for recording at least one mark reference parameter of the indicating mark.

3. The 3D size measuring system according to claim 2, wherein the spatial vector calculating module further comprises:
an image processing module, for determining a regional image corresponding to the indicating mark in the image;
a compare module, for comparing the regional image with the mark reference parameter provided by the indicating mark parameter module;
a reliability judgement module, for determining a correlation reliability between the regional image and the indicating mark;
a dynamic tracking module, wherein when the correlation reliability is high, the dynamic tracking module tracks moving regional images around the regional image, and the moving regional images respectively correspond to the indicating marks used to point to the measuring points on the object around the regional image, so that the dynamic tracking module calculates the spatial vectors corresponding to the indicating mark pointing to each of the measuring points according to a comparison made by the compare module between each of the moving regional image and at least one mark reference parameter provided by the indicating mark parameter module; and
a real-time compare module, wherein when the correlation reliability is low, the image processing module re-determines the regional image corresponding to the indicating mark pointing to each of the measuring points in the image, so as to calculate the spatial vectors corresponding to the indicating mark pointing to each of the measuring points according to the comparison made by the compare module between each of the regional image and the mark reference parameter provided by the indicating mark parameter module.

4. The 3D size measuring system according to claim 1, wherein the indicating mark comprises a mark portion and an indicator portion extending outwards from the mark portion, wherein the indicator portion is used to point to one of a plurality of measuring points on the object, and the mark portion comprises at least one identification pattern.

5. The 3D size measuring system according to claim 4 further comprising:
an image processing module, for determining a regional image corresponding to the indicating mark in the image, wherein the image processing module determines the regional image corresponding to the indicating mark in the image according to the identification pattern.

6. The 3D size measuring system according to 1, wherein the measuring module further comprises:
a line segment measuring module, for calculating a distance between any two of the measuring points according to the spatial coordinates of the measuring points on the object.

7. The 3D size measuring system according to claim 1, wherein the measuring module further comprises:
a track recording module, for recording the spatial coordinates of the measuring points on the object according to a sequence of the measuring points which the indicating mark is used to point to on the object, so as to obtain a measurement path of the indicating mark.

8. The 3D size measuring system according to claim 1 further comprising:
a 3D virtual space constructing module, for constructing a 3D virtual space in a spatial coordinate system corresponding to the image; and
a space measuring module, for measuring a spatial relationship between the 3D size of the object and the 3D virtual space.

9. The 3D size measuring system according to claim 1 further comprising:
a graphing module, for plotting a corresponding digital content according to the spatial coordinates of the measuring points, wherein the digital content is a 3D virtual image, a 3D model, or a picture of the object.

10. The 3D size measuring system according to claim 1, wherein the indicating mark is used to point to a rear measuring point on the object opposite to the image capturing module through the indicator portion, and the indicator portion is partially shielded in the image; and
the spatial vector calculating module calculates the spatial vector corresponding to the indicating mark pointing to the rear measuring point on the object opposite to the image capturing module according to the image of the indicating mark with the indicator portion being partially shielded in the image.

11. A 3D size measuring method, adaptable to an electronic device, for measuring an object in a space according to an indicating mark, wherein the indicating mark is used to point to one of a plurality of measuring points on the object, and the electronic device executes following steps:
capturing an image of the space;
according to the indicating mark pointing to each of the measuring points on the object in the image, respectively calculating a spatial vector corresponding to the indicating mark pointing to each of the measuring points; and
calculating spatial coordinate of each of the measuring points according to the spatial vectors, so as to obtain a 3D size of the object.

12. The 3D size measuring method according to claim 11 further comprising:
recording at least one mark reference parameter of the indicating mark.

13. The 3D size measuring method according to claim 12 further comprising:
determining a regional image corresponding to the indicating mark in the image;
comparing the regional image with the mark reference parameter;
determining a correlation reliability between the regional image and the indicating mark;
when the correlation reliability is high, tracking movingregional images around the regional image, so that the spatial vectors corresponding to the indicating mark pointing to each of the measuring points is calculated according to a comparison between each of the moving regional image and at least one mark reference parameter, wherein the moving regional images respectively correspond to the indicating mark that is used to point to the measuring points on the object around the regional image; and
when the correlation reliability is low, determining the regional image corresponding to the indicating mark pointing to each of the measuring points in the image again, so as to calculate the spatial vectors corresponding to the indicating mark pointing to each of the measuring points according to the comparison between each of the regional image and the mark reference parameter.

14. The 3D size measuring method according to claim 11, wherein the indicating mark comprises a mark portion and an indicator portion extending outwards from the mark portion, wherein the indicator portion is used to point to one of a plurality of measuring points on the object, and the mark portion comprises at least one identification pattern.

15. The 3D size measuring method according to claim 14 further comprising:
determining a regional image corresponding to the indicating mark in the image according to the identification pattern.

16. The 3D size measuring method according to claim 11 further comprising:
calculating a distance between any two of the measuring points according to the spatial coordinates of the measuring points on the object.

17. The 3D size measuring method according to claim 11 further comprising:
recording the spatial coordinates of the measuring points on the object according to a sequence of the measuring points which the indicating mark is used to sequentially point to on the object, so as to obtain a measurement path of the indicating mark.

18. The 3D size measuring method according to claim 11 further comprising:
constructing a 3D virtual space in a spatial coordinate system corresponding to the image; and
measuring a spatial relationship between the 3D size of the object and the 3D virtual space.

19. The 3D size measuring method according to claim 11 further comprising:
plotting a corresponding digital content according to the spatial coordinates of the measuring points, wherein the digital content is a 3D virtual image, a 3D model, or a picture of the object.

20. The 3D size measuring method according to claim 11, wherein the indicating mark is used to point to a rear measuring point on the object opposite to the image capturing module through the indicator portion, and the indicator portion is partially shielded in the image; and
a spatial vector corresponding to the indicating mark pointing to the rear measuring point on the object opposite to the electronic device is calculated according to the image of the indicating mark with the indicator portion being partially shielded in the image.

21. A computer-readable recording medium, for storing a 3D size measuring program, wherein the 3D size measuring program allows an electronic device to measure an object in a space according to an indicating mark, the indicating mark is used to point to one of a plurality of measuring points on the object, and the 3D size measuring program has a plurality of instructions for executing following steps:
capturing an image of the space;
according to the indicating mark pointing to each of the measuring points on the object in the image, respectively calculating a spatial vector corresponding to the indicating mark pointing to each of the measuring points; and
calculating spatial coordinate of each of the measuring points according to the spatial vectors, so as to obtain a 3D size of the object.
